(19) United States
(12) Patent Application Publication
(10) Pub. No.: US 2026/0094252 A1
(43) Pub. Date: Apr. 2, 2026

(54) DEVICE SEAL LIGHT LEAKAGE CORRECTION

(71) Applicant: Apple Inc., Cupertino, CA (US)

(72) Inventors: Praveen Gowda Ippadi Veerabhadre Gowda, San Jose, CA (US); Frank Bollack, Mountain View, CA (US); Shiuli Das, Fremont, CA (US); Yuri Pekelny, Seattle, WA (US); Thomas Berton, San Francisco, CA (US); Ransen Niu, Milpitas, CA (US); Daniel Kurz, San Francisco, CA (US)

(21) Appl. No.: 19/318,596

(22) Filed: Sep. 4, 2025

Related U.S. Application Data
(60) Provisional application No. 63/700,549, filed on Sep. 27, 2024.

(51) Int. Cl. G06T 7/00; G02B 27/01

(52) U.S. Cl. CPC G06T 7/0002; G02B 27/017; G02B 2027/0138; G06T 2207/20081; G06T 2207/30201

(57) ABSTRACT

Various implementations disclosed herein include devices, systems, and methods that predict a proper light seal fit for a head mounted device (HMD) to reduce external light leakage into the HMD. For example, a process may include obtaining first images of a portion of a face of a user while the user is wearing the HMD and initial light seal contacts at least some perimeter regions around the portion of the face such that the HMD forms an enclosed area between the HMD and the portion of the face. Based on the first images illumination characteristics may be identified on the portion of the face corresponding to external light entering the enclosed area via one or more light source leakage regions between the face and the initial light seal. Based on the identified illumination characteristics one or more parameters for an adjusted light seal for the user may be determined.

### CROSS REFERENCE TO RELATED APPLICATIONS

This application claims the benefit of U.S. Provisional Application Ser. No. 63/700,549 filed Sep. 27, 2024, which is incorporated herein in its entirety.

### TECHNICAL FIELD

The present disclosure generally relates to systems, methods, and devices that predict a proper light seal fit for a head mounted device (HMD) to reduce external light leakage into a viewing area of the HMD.

### BACKGROUND

Existing content presentation systems may be improved with respect to mitigating external lighting issues to provide desirable and enhanced viewing experiences via a wearable device.

### SUMMARY

Various implementations disclosed herein include devices, systems, and methods that are configured to recommend a replacement light seal or adjust an existing light seal of an HMD to ensure a proper light seal fit for reducing external light leakage/intrusion into a viewing area inside of the HMD. In some scenarios, external light leakage issues with respect to a viewing area of an HMD may be a function of external light sources surrounding a user with respect to a shape of a user's face and a quality of a light seal (of the HMD) fit with respect to the user's face.

Accordingly, a process for determining a proper light seal fit with respect to a user's face may include providing a generic light seal for a user to wear with an HMD and modeling external light sources while the user is wearing the HMD with the generic light seal in a real environment. In some implementations, modeling external light sources may include analyzing camera images obtained from external facing cameras of the HMD. In response to analyzing the camera images, shadow patterns and illumination patterns produced in areas surrounding eyes of the user may be identified from, for example, images captured by internal facing cameras of the HMD. In some implementations, the shadow patterns and illumination patterns may be used to determine geometric fit parameters requiring adjustment. In some implementations, the geometric fit parameters may include angular parameters, curvature parameters, depth parameters, etc. associated with a facial region of the user. In some implementations, external light sources being modeled may include ambient light sources existing in a real environment. In some implementations, external light sources being modeled may include strategically placed light sources such as, for example, a light ring placed around the light seal and/or the HMD.

In some implementations, a process for determining a proper light seal fit may include providing a generic light seal for a user to wear with an HMD and only using internal facing cameras of the HMD (i.e., without modeling external light sources) to capture images in areas surrounding eyes of the user. The images may be processed by a machine learning (ML) model, synthetic simulation techniques, and/or rule-based models to simulate different light seal fit issues and synthetically generate resulting shadow and illumination patterns for determining geometric fit parameters requiring adjustment.

In some implementations, the process may be configured to detect light leakage into the HMD and suggest a corrective action such as, inter alia, recommending a specific adjustment or prompting the user to obtain a new light seal. For example, the process may be configured to detect light seal leakage when a user is wearing the HMD. In response, an algorithm may be executed for comparing a current light profile of light inside the HMD with a no-leakage light profile (e.g., generated during product development) to detect discrepancies between the light profiles. Based on the characteristics of the discrepancies, the process may determine locations with respect to the light seal that are allowing light leakage and recommend corrective actions to the user, such as, inter alia, (1) identifying and recommending a correct light seal based on a leakage pattern to the user or (2) requesting that the user adjust a position and/or remove or add features such as a removable face cushion of the HMD to correct for the light leakage.

In some implementations, an HMD has a processor (e.g., one or more processors) that executes instructions stored in a non-transitory computer-readable medium to perform a method. The method performs one or more steps or processes. In some implementations, the HMD obtains first images of a portion of a face of a user while the user is wearing the HMD and an initial light seal contacts at least some perimeter regions around the portion of the face such that the HMD forms an enclosed area between the HMD and the portion of the face. In some implementations, based on the first images, illumination characteristics on the portion of the face corresponding to external light entering the enclosed area via one or more light source leakage regions between the face and the initial light seal may be identified. One or more parameters for an adjusted light seal for the user may be determined based on the identified illumination characteristics.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an exemplary electronic device operating in a physical environment corresponding to an extended reality (XR) environment, in accordance with some implementations.

FIG. 2 illustrates a view of light sources producing lighting patterns in a physical environment, in accordance with some implementations.

FIG. 3 illustrates an example of a view of a light seal and a view of a body of an HMD, in accordance with some implementations.

FIG. 4 illustrates a view of images obtained from internal facing cameras of an HMD, in accordance with some implementations.

FIGS. 5A and 5B illustrate views of an interface presenting multiple images obtained from internal facing cameras of an HMD, in accordance with some implementations.

FIG. 6 is a flowchart representation of an exemplary method that predicts a proper light seal fit for an HMD to reduce external light leakage into a viewing area of the HMD, in accordance with some implementations.

FIG. 7 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

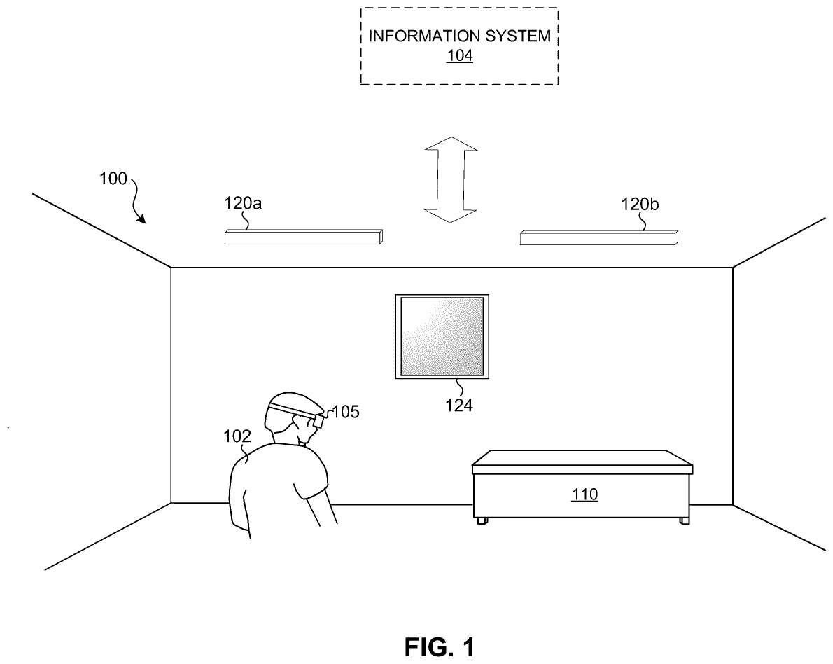

FIG. 1 illustrates an exemplary electronic device 105 operating in a physical environment 100 corresponding to an extended reality (XR) environment. Additionally, electronic device 105 may be in communication with an information system 104 (e.g., a device control framework or network). In an exemplary implementation, electronic device 105 is sharing information with the information system 104. In the example of FIG. 1, the physical environment 100 is a room that includes a window 124 and physical objects such as a desk 110, a light source 120a, and a light source 120b. The electronic device 105 may include one or more cameras, microphones, depth sensors, or other sensors that can be used to capture information about and evaluate the physical environment 100 and the objects within it, as well as information about the user 102 of electronic device 105. The information about the physical environment 100 and/or user 102 may be used to provide visual and audio content and/or to identify the current location of the physical environment 100 and/or the location of the user within the physical environment 100.

In some implementations, views of an extended reality (XR) environment may be provided to one or more participants (e.g., user 102 and/or other participants not shown) via electronic device 105 (e.g., a wearable device such as an HMD). Such an XR environment may include views of a 3D environment that is generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system associated with the XR environment, which may correspond to a 3D coordinate system of the physical environment 100.

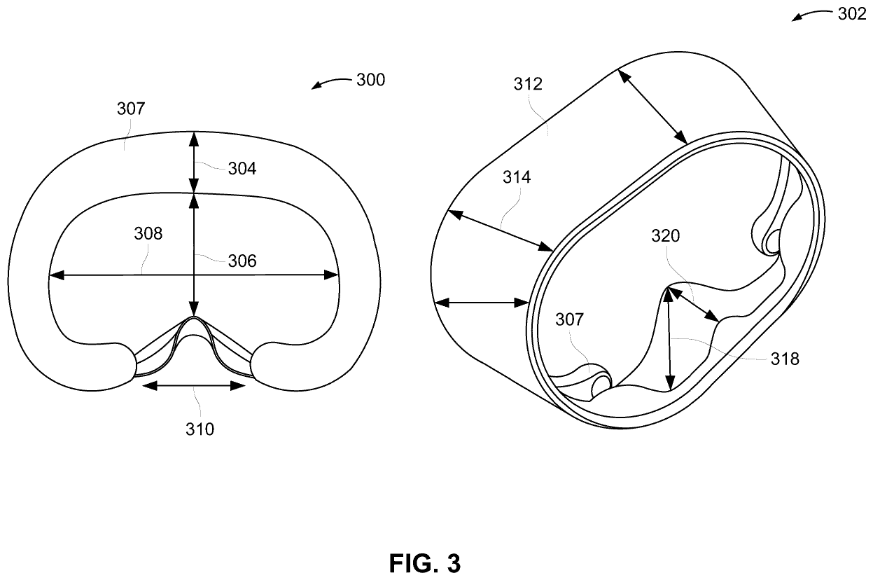

In some implementations, an HMD (e.g., device 105), optionally communicatively coupled a server, or other external device (e.g., information system 104) may be configured to obtain first images of a portion of a face of a user (e.g., user 102) while the user is wearing the HMD such that a light seal (e.g., light seal 307 as illustrated in FIG. 3) of the HMD contacts at least some perimeter regions surrounding the portion of the face of the user such that the HMD in combination with the light seal form an enclosed region between the HMD and the portion of the face of the user. For example, a portion of a face of the user may include a region (of the face of the user) surrounding eyes of the user.

In some implementations, the first images may be used to identify illumination characteristics such as illumination patterns and/or shadow patterns on the portion of the face. The illumination patterns and/or shadow patterns may correspond to external light entering the enclosed area via one or more light source leakage regions such as gaps located between the face of the user and the light seal. In some implementations, the external light entering the enclosed area may come from ambient light sources such as, inter alia, ambient light from: window 124, light source 120a, and/or light source 120b (e.g., overhead lighting). In some implementations, the external light entering the enclosed area may come from strategically placed light sources such as, for example, a light ring (e.g., an infrared (IR) light ring) placed around the light seal and/or the HMD.

In some implementations, one or more parameters for an adjusted light seal for the user may be determined based on the identified illumination characteristics. In some implementations, the one or more parameters may include geometric fit parameters requiring adjustment. For example, the geometric fit parameters may include angular parameters, curvature parameters, depth parameters, etc. associated with a facial region(s) of the user.

In some implementations, the geometric fit parameters for an adjusted light seal may be used to provide a recommendation (to the user) specifying a light seal or a light seal adjustment providing fewer or no light source leakage regions.

In some implementations, external light source locations may be determined via external sensors (e.g., external facing cameras) capturing images and modeling the external light sources to identify shadow patterns and illumination patterns created in the enclosed area of the HMD (e.g., an area surrounding eyes of the user) from images captured by internal facing cameras of the HMD.

In some implementations, an ML model, synthetic simulation techniques, and/or rule-based models may be used to simulate different light seal fit issues and synthetically generate resulting shadow and illumination patterns for determining geometric fit parameters requiring adjustment.

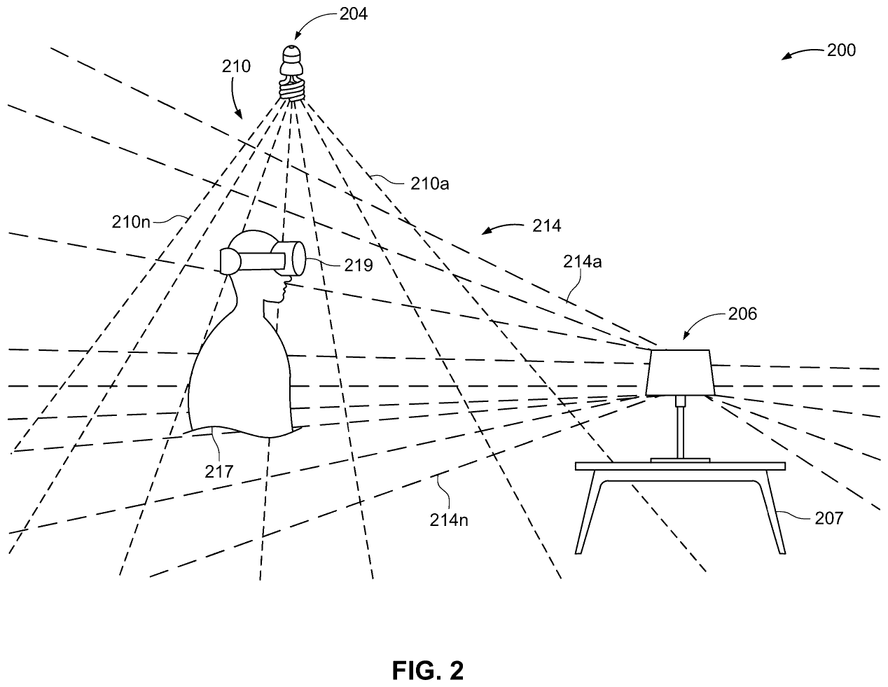

FIG. 2 illustrates a view of light sources 204 and 206 producing lighting patterns 210 and 214 in a physical environment 200, in accordance with some implementations. Light source 204 may be, for example, an overhead light (e.g., incandescent, LED, florescent, etc.) producing ambient light producing light leakage (via lighting pattern 210) within a viewing area of an HMD 219 being worn by a user 217. Light source 206 may be, for example, a lamp (e.g., on a table 207) producing ambient light producing light leakage (via lighting pattern 210) within a viewing area of HMD 219 being worn by user 217. In some implementations, ambient light producing light leakage within a viewing area of HMD 219 being worn by user 217 may result from, inter alia, natural light from a window, a lighting structure/source placed around HMD 219 or a light seal of HMD 219, etc. In some implementations, lighting pattern 210 includes multiple (directional) rays of light 210a . . . 210n produced by light source 204. In some implementations, lighting pattern 214 includes multiple (directional) rays of light 214a . . . 214n produced by light source 206.

In some implementations, a fit of HMD 219 with respect to user 217 may be optimized by adjusting or replacing a light seal (e.g., light seal 307 as described with respect to FIG. 3) of HMD 219 to eliminate or reduce light leakage, for example, from lighting patterns 210 and/or 214.

For example, in some implementations, user 217 may be provided with a generic light seal (e.g., a neutral style and size such as small, medium or large) for use as a baseline fit to determine how well it blocks external light from lighting patterns 210 and/or 214. In some implementations, inward facing cameras (e.g., eye tracking cameras) may be used to capture images that may reveal light leak issues. For example, inward facing cameras may detect light entering a viewing area of HMD 219 thereby enabling a process for mapping areas associated with light source leakage regions such as, gaps, etc. between a face of user 217 and the light seal.

In some implementations, an environmental modeling process may be implemented to enable outward facing cameras (e.g., used for environment sensing) to model (e.g., via synthetic simulation techniques and/or rule-based models) lighting patterns 210 and 214 of light sources 204 and 206 in physical environment 200. The modeled lighting patterns 210 and 214 may be used to predict light leakage areas of the light seal based on shadow and light reflection behavior within HMD 219 thereby providing an accurate simulation of external light sources 204 and 206 interactions with the light seal and whether external light penetrates into the viewing area of HMD 219.

In some implementations, machine learning (ML) models may be used to predict where light leakage (into HMD 219) may occur. For example, an ML model may use training data to learn and predict light leakage areas based on patterns observed within inward facing camera feeds, without the need to explicitly model external light sources 204 and 206. For example, training data may include images from inward facing cameras across various users and associated head shapes and lighting environments and may include instances of light leakage. Subsequently, the ML model may use data from inward facing cameras of HMD 219 to identify features related to light leakage. For example, features may include brightness gradients, irregular shadowing, facial geometry from eye-tracking data, etc. Over time, the ML model may be configured to suggest better light seal fits or adjustments based on a shape and size of user's 217 face captured via the inward facing cameras.

In some implementations, a rule-based deterministic approach may be used to predict light leakage (into HMD 219) based on observed lighting patterns by creating a structured set of rules that interpret lighting data from sensors (e.g., cameras or other detection systems) and predict where light is leaking. For example, a position of detected light may be correlated with known external light source positions (e.g., a light ring place around the HMD 219) and if an intensity of the detected light matches an intensity of the known external light source, it may be determined that light leakage is occurring. Alternatively, expected internal lighting patterns may be compared to detected internal lighting patterns (e.g., obtained from images from inward facing cameras of the HMD 219) from external light sources and if the detected internal lighting patterns deviate significantly from the expected internal lighting patterns, this may indicate light leakage.

In some implementations, the following process for modeling light sources in physical environment 200 may include using outward facing cameras to capture environment data that includes positions, intensities, and types of light sources (e.g., light sources 204 and 206) in physical environment 200. Subsequently, a 3D model of physical environment 200 may be generated by mapping physical environment 200 into a 3D environment, including furniture, walls, and reflective surfaces to determine potential indirect light source leaks. Likewise, a behavior of light sources 204 and 206 may be simulated using light ray tracing or shadow modeling techniques to simulate how light from light sources 204 and 206 interacts with a face of user 217 with respect to HMD 219. Light ray tracing or shadow modeling techniques may be configured to project the paths of rays of light (e.g., rays of light 210a . . . 210n and 214a . . . 214n) to determine where they may leak into HMD 219 based on environmental factors and a fit of the light seal of HMD 219 with respect to a face of user 217.

In some implementations, inward facing cameras may be configured to detect shadow patterns on a face of user 217. Any irregular shadowing or unusual brightness being detected inside a viewing area of HMD 219 may indicate a potential light leak. The detected shadow patterns in combination with modeled lighting patterns 210 and 214 of light sources 204 and 206 may be used to confirm whether the light leak is coming from one or more external lights such as light sources 204 and 206.

In some implementations, the aforementioned processes may be used to recommend adjustments to the light seal such as, for example, tightening regions of the light seal, using a light seal of a different size and/or shape, blocking light sources in physical environment 200, adjusting a position of the HMD 219, etc.

In some implementations, a combination of environmental modeling and ML modeling may be used to enable a personalized light seal fit for user 217 thereby improving both comfort and device performance by reducing light seal light leakage. For example, light source modeling may be initially used to build an understanding of physical environment 200 and identify approximate sources of light leaks and subsequently, the ML model may fine-tune light source leak predictions thereby improving based on real-time inward facing camera data and learning from previously detected light source leaks.

FIG. 3 illustrates an example of a view 300 of a light seal 307 and a view 302 of a body 312 of an HMD, in accordance with some implementations. In some implementations, light seal 307 may be optimized to minimize external light leakage by enabling an environmental modeling process and/or ML model prediction processes as described, supra, with respect to FIG. 2. In some implementations, external ambient lighting (e.g., overhead lights, outside light from a window, etc.) may be used to perform an environmental modeling process. In some implementations, a lighting structure such as a ring of lights placed around the HMD may be used to simulate external light conditions for detecting light leaks during a user enrollment process.

In some implementations, light seal 307 may be adjusted and/or replaced by a personalized light seal to minimize light leakage by modifying distances associated with light seal 307. For example, distances 304, 306, 308, and/or 310 may be increased or decreased to create a better fit to the face of a user thereby minimizing light leakage.

In some implementations, a distance between the eyes of a user and a display of the HMD may be adjusted or maintained to provide a safe and desirable viewing experience. The distance between the eyes of the user the display of the HMD may be controlled adjusting or replacing light seal 307 to increase and/or decrease distances 314, 318, and/or 320 to minimize light seal light leakage and maintain an adequate field of view (FoV) of the user with respect to a display of the HMD. For example, a geometry of the light seal 307 including a width, a curvature, and a tightness may be modified to ensure an adequate and comfortable fit. Likewise, a headband of the HMD may be adjusted to increase or decrease tightness adjust the light seal 307 as well.

In some implementations, a simulator may be run with respect to the geometric fit parameters such as width, angle, curvature, depth, etc. of a user's face to simulate different fits for a user prior to physically using the HMD. For example, a simulator could produce several initial light seal fit options for a user to try in a real-world test with use of a lighting ring setup for confirmation.

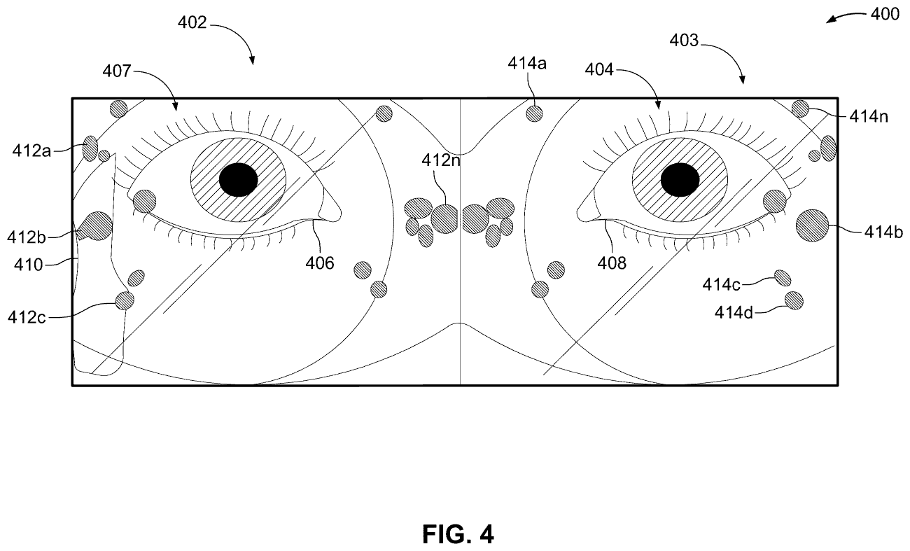

FIG. 4 illustrates a view 400 of images obtained from internal facing cameras of an HMD, in accordance with some implementations. View 400 illustrates shadow and illumination regions produced as a function of light sources surrounding a user of an HMD, a shape of the user's face, and a quality of a light seal fit with respect to the user's face. The shadow and illumination regions presented with respect to the images may be analyzed and mapped to light seal parameters to adjust a fit of the light seal. For example, the images include a left eye image 402 and a right eye image 403. Left eye image 402 includes shadow regions 407 and illumination regions 412a . . . 412n located in areas with respect to a left eye 406 of the user. Likewise, right eye image 403 includes shadow regions 404 and illumination regions 414a . . . 414n located in areas with respect to a right eye 408 of the user.

In some implementations, left eye image 420 with shadow regions 407 and illumination regions 412a . . . 412n and right eye image 403 with shadow regions 404 and illumination regions 414a . . . 414n may be generated by:
1. Developing a synthetic model of light sources in a physical environment and a generic light seal fit with respect to a face of a user.
2. Simulating different light seal fit issues and synthetically generating resulting shadow and illumination patterns (e.g., shadow regions 407 and illumination regions 412a . . . 412n and shadow regions 404 and illumination regions 414a . . . 414n).
3. Running a clustering algorithm to gather areas of illumination and shadow regions (e.g., region 410) from eye cam images such as left eye image 402 and right eye image 403.
4. Running an analysis to determine a closest match for clusters resulting from the clustering algorithm with respect to the synthetic patterns (e.g., shadow regions 407 and illumination regions 412a . . . 412n and shadow regions 404 and illumination regions 414a . . . 414n). The analysis may result in determining light seal parameters for adjustment to reduce light leakage issues.

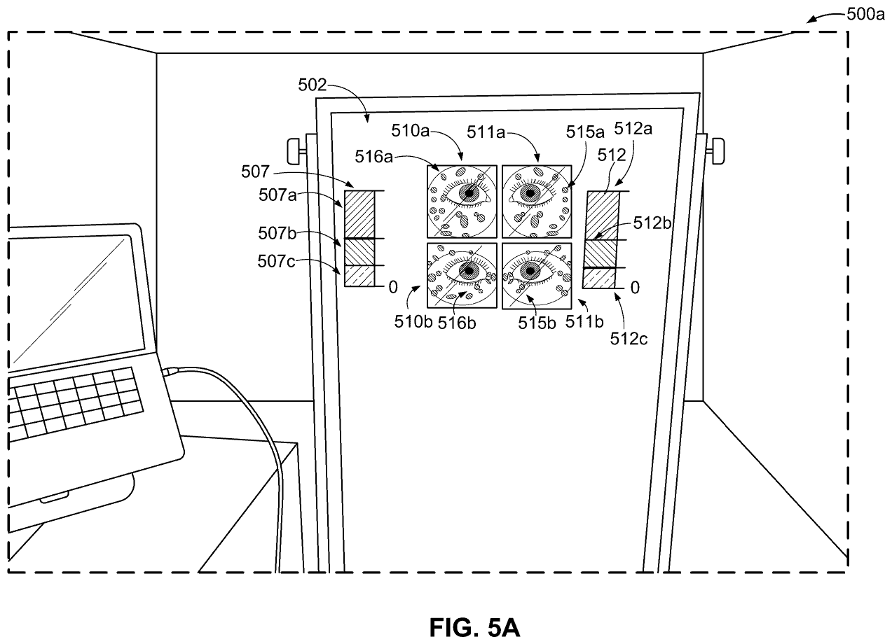

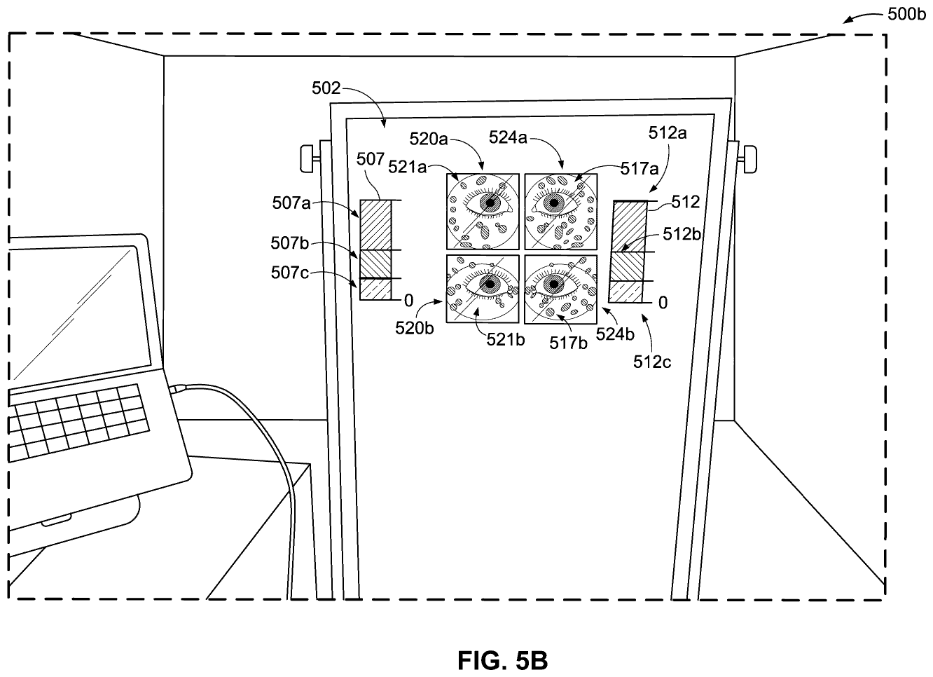

FIGS. 5A and 5B illustrate views 500a and 500b of an interface 502 presenting multiple images obtained from internal facing cameras of an HMD, in accordance with some implementations.

FIG. 5A illustrates view 500a of interface 502 presenting images at a first instant in time. For example, view 500a illustrates shadow and illumination regions produced as a function of light sources surrounding a user of an HMD, a shape of the user's face, and a quality of a light seal fit with respect to the user's face. The shadow and illumination regions presented with respect to the images may be analyzed and mapped to light seal parameters to adjust a fit of the light seal. For example, the images include left eye images 510a and 510b and right eye images 511a and 511b. Left eye image 510a includes shadow and illumination regions 516a located in areas with respect to a left eye of the user. Left eye image 510b includes shadow and illumination regions 516b located in areas with respect to a left eye of the user subsequent to movement by the user (e.g., eye and/or head movement). Likewise, right eye image 511a includes shadow and illumination regions 515a located in areas with respect to a right eye of the user. Right eye image 511b includes shadow and illumination regions 515b located in areas with respect to a right eye of the user subsequent to movement by the user (e.g., eye and/or head movement).

The differences between left eye image 510a and left eye image 510b result in differences between shadow and illumination regions 516a and shadow and illumination regions 516b illustrated for the user via regions 507a, 507b, and 507c of an indicator 507. For example, indicator 507 represents shadow and illumination regions 516a and 516b within a level associated with region 507b thereby indicating a level that does not require a light seal adjustment. Likewise, the differences between right eye image 511a and right eye image 511b result in differences (e.g., differences in location, size, shape, intensity/brightness, etc.) between shadow and illumination regions 515a and shadow and illumination regions 515b illustrated for the user via regions 512a, 512b, and 512c of an indicator 512. For example, indicator 512 represents shadow and illumination regions 515a and 515b within a level associated with region 512c thereby indicating a level that does not require a light seal adjustment.

FIG. 5B illustrates view 500b of interface 502 presenting images at a second instant in time subsequent to the first instant in time as illustrated in FIG. 5A. For example, view 500b illustrates shadow and illumination regions produced as a function of light sources surrounding a user of an HMD, a shape of the user's face, and a quality of a light seal fit with respect to the user's face subsequent to eye and face movement of the user with respect to view 500a of FIG. 5A. The shadow and illumination regions presented with respect to the images may be analyzed and mapped to light seal parameters to adjust a fit of the light seal. For example, the images include a left eye images 520a and 520b and right eye images 524a and 524b. Left eye image 520a includes shadow and illumination regions 521a located in areas with respect to a left eye of the user. Left eye image 520b includes shadow and illumination regions 521b located in areas with respect to a left eye of the user subsequent to movement by the user (e.g., eye and/or head movement). Likewise, right eye image 524a includes shadow and illumination regions 517a located in areas with respect to a right eye of the user. Right eye image 524b includes shadow and illumination regions 517b located in areas with respect to a right eye of the user subsequent to movement by the user (e.g., eye and/or head movement).

The differences between left eye image 520a and left eye image 520b result in differences between shadow and illumination regions 521a and shadow and illumination regions 521b illustrated for the user via regions 507a, 507b, and 507c of indicator 507. For example, indicator 507 in FIG. 5B represents shadow and illumination regions 521a and 521b within a level associated with region 507c thereby indicating a level that does not require a light seal adjustment. Likewise, the differences between right eye image 524a and right eye image 524b result in differences between shadow and illumination regions 517a and shadow and illumination regions 517b illustrated for the user via regions 512a, 512b, and 512c of indicator 512. For example, indicator 512 represents shadow and illumination regions 517a and 517b within a level associated with region 512a thereby indicating a level requiring a light seal adjustment. In some implementations, a recommendation indicating a light seal adjustment type may be generated and presented to a user. For example, if it is determined that light leakage is occurring in areas between a light seal and cheekbone regions of a user's face, a different light seal that includes a profile to better fit the cheekbone regions may be recommended.

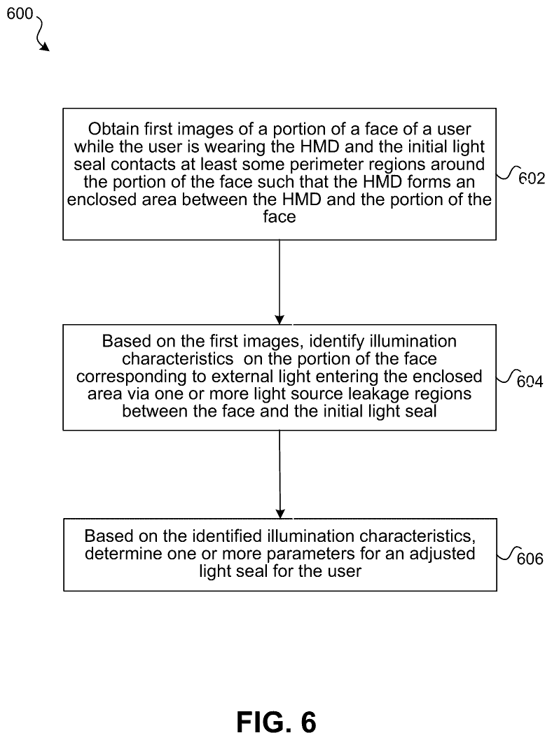

FIG. 6 is a flowchart representation of an exemplary method 600 that predicts a proper light seal fit for an HMD to reduce external light leakage into a viewing area of the HMD, in accordance with some implementations. In some implementations, the method 600 is performed by a device(s), such as a tablet device, mobile device, desktop, laptop, HMD, server device, information system, etc. In some implementations, the device has a screen for displaying images and/or a screen for viewing stereoscopic images such as a head-mounted display (HMD such as e.g., electronic device 105 of FIG. 1). In some implementations, the device (e.g., an HMD) includes inward facing cameras, outward facing cameras, and an initial light seal (e.g., light seal 307 as described with respect to FIG. 3). In some implementations, the method 600 is performed by processing logic, including hardware, firmware, software, or a combination thereof. In some implementations, the method 600 is performed by a processor executing code stored in a non-transitory computer-readable medium (e.g., a memory). Each of the blocks in the method 600 may be enabled and executed in any order.

At block 602, the method 600 obtains first images of a portion of a face of a user while the user is wearing the HMD and the initial light seal contacts at least some perimeter regions around the portion of the face such that the HMD forms an enclosed area between the HMD and the portion of the face. For example, a light source 204 may be an overhead light producing light leakage within a viewing area of an HMD 219 being worn by a user 217 as described with respect to FIG. 2.

In some implementations, the first images may be obtained by internal facing cameras of the HMD.

At block 604, the method 600, based on the first images identifies illumination characteristics such as, for example, illumination/shadow patterns on the portion of the face corresponding to external light entering the enclosed area via one or more light source leakage regions such as gaps located between the face and the initial light seal. For example, a left eye image 510a that include shadow and illumination regions 516a located in areas with respect to a left eye of user as described with respect to FIG. 5A.

At block 606, the method 600 based on the identified illumination characteristics, determines one or more parameters for an adjusted light seal for the user. For example, geometric fit parameters such as width, angle, curvature, depth, etc. of a user's face as described with respect to FIG. 3.

In some implementations, determining the one or more parameters for the adjusted light seal may include modeling external light sources (ambient or strategically placed) in a physical environment of the user wearing the HMD by: obtaining second images of the physical environment from external facing cameras of the HMD and analyzing the second images to identify the illumination characteristics of the first images as described with respect to FIG. 2.

In some implementations, determining the one or more parameters for the adjusted light seal may include generating the illumination characteristics with respect to the first images based on simulated attributes of the light seal with respect to contact the face to determine the one or more parameters.

In some implementations, generating the illumination characteristics with respect to the first images is performed using a rule-based algorithm.

In some implementations, generating the illumination characteristics with respect to the first images is performed using a machine learning (ML) model.

In some implementations, the one or more parameters include geometric fit parameters associated with a shape of the face of the user requiring adjustment.

In some implementations, the geometric fit parameters comprise parameters such as, inter alia, angular parameters, curvature parameters, depth parameters, etc.

In some implementations, illumination characteristics may include illumination and shadow patterns located in areas surrounding eyes of the user.

In some implementations, a recommendation for using the adjusted light seal to provide geometric fit parameters to reduce the light source leakage regions may be generated for the user.

In some implementations, the adjusted light seal may be a replacement light seal for replacing the initial light seal.

In some implementations, the adjusted light seal may be an adjusted version of the initial light seal.

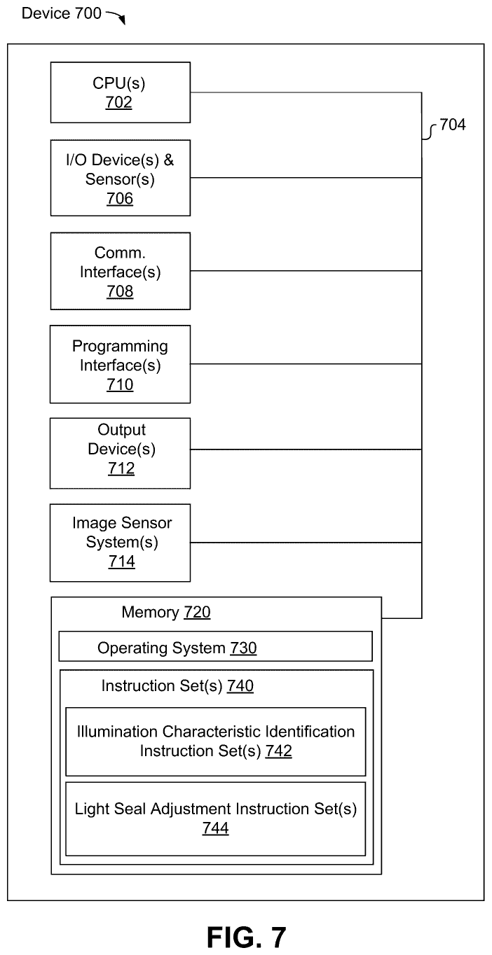

FIG. 7 is a block diagram of an example device 700. Device 700 illustrates an exemplary device configuration for electronic device 105 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 700 includes one or more processing units 702 (e.g., microprocessors, ASICs, FPGAs, GPUs, CPUs, processing cores, and/or the like), one or more input/output (I/O) devices and sensors 704, one or more communication interfaces 708 (e.g., USB, FIREWIRE, THUNDERBOLT, IEEE 802.3x, IEEE 802.11x, IEEE 802.14x, GSM, CDMA, TDMA, GPS, IR, BLUETOOTH, ZIGBEE, SPI, I2C, and/or the like type interface), one or more programming (e.g., I/O) interfaces 710, output devices (e.g., one or more displays) 712, one or more interior and/or exterior facing image sensor systems 714, a memory 720, and one or more communication buses 704 for interconnecting these and various other components.

In some implementations, the one or more communication buses 704 include circuitry that interconnects and controls communications between system components. In some implementations, the one or more I/O devices and sensors 706 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), one or more cameras (e.g., inward facing cameras and outward facing cameras of an HMD), one or more infrared sensors, one or more heat map sensors, and/or the like.

In some implementations, the one or more displays 712 are configured to present a view of a physical environment, a graphical environment, an extended reality environment, etc. to the user. In some implementations, the one or more displays 712 are configured to present content (determined based on a determined user/object location of the user within the physical environment) to the user. In some implementations, the one or more displays 712 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 712 correspond to diffractive, reflective, polarized, holographic, etc. waveguide displays. In one example, the device 700 includes a single display. In another example, the device 700 includes a display for each eye of the user.

In some implementations, the one or more image sensor systems 714 are configured to obtain image data that corresponds to at least a portion of the physical environment 100. For example, the one or more image sensor systems 714 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 714 further include illumination sources that emit light, such as a flash. In various implementations, the one or more image sensor systems 714 further include an on-camera image signal processor (ISP) configured to execute a plurality of processing operations on the image data.

In some implementations, sensor data may be obtained by device(s) (e.g., devices 105 and 110 of FIG. 1) during a scan of a room of a physical environment. The sensor data may include a 3D point cloud and a sequence of 2D images corresponding to captured views of the room during the scan of the room. In some implementations, the sensor data includes image data (e.g., from an RGB camera), depth data (e.g., a depth image from a depth camera), ambient light sensor data (e.g., from an ambient light sensor), and/or motion data from one or more motion sensors (e.g., accelerometers, gyroscopes, IMU, etc.). In some implementations, the sensor data includes visual inertial odometry (VIO) data determined based on image data. The 3D point cloud may provide semantic information about one or more elements of the room. The 3D point cloud may provide information about the positions and appearance of surface portions within the physical environment. In some implementations, the 3D point cloud is obtained over time, e.g., during a scan of the room, and the 3D point cloud may be updated, and updated versions of the 3D point cloud obtained over time. For example, a 3D representation may be obtained (and analyzed/processed) as it is updated/adjusted over time (e.g., as the user scans a room).

In some implementations, sensor data may be positioning information, some implementations include a VIO to determine equivalent odometry information using sequential camera images (e.g., light intensity image data) and motion data (e.g., acquired from the IMU/motion sensor) to estimate the distance traveled. Alternatively, some implementations of the present disclosure may include a simultaneous localization and mapping (SLAM) system (e.g., position sensors). The SLAM system may include a multidimensional (e.g., 3D) laser scanning and range-measuring system that is GPS independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In some implementations, the device 700 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 700 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 700.

The memory 720 includes high-speed random-access memory, such as DRAM, SRAM, DDR RAM, or other random-access solid-state memory devices. In some implementations, the memory 720 includes non-volatile memory, such as one or more magnetic disk storage devices, optical disk storage devices, flash memory devices, or other non-volatile solid-state storage devices. The memory 720 optionally includes one or more storage devices remotely located from the one or more processing units 702. The memory 720 includes a non-transitory computer readable storage medium.

In some implementations, the memory 720 or the non-transitory computer readable storage medium of the memory 720 stores an optional operating system 730 and one or more instruction set(s) 740. The operating system 730 includes procedures for handling various basic system services and for performing hardware dependent tasks. In some implementations, the instruction set(s) 740 include executable software defined by binary information stored in the form of electrical charge. In some implementations, the instruction set(s) 740 are software that is executable by the one or more processing units 702 to carry out one or more of the techniques described herein.

The instruction set(s) 740 includes an illumination characteristic identification instruction set 742 and a light seal adjustment instruction set 744. The instruction set(s) 740 may be embodied as a single software executable or multiple software executables.

The illumination characteristic identification instruction set 742 is configured with instructions executable by a processor to identify illumination characteristics such as illumination and shadow patterns on a face of a user that correspond to external light entering an enclosed area via e.g., gaps between the face and a light seal.

The light seal adjustment instruction set 744 is configured with instructions executable by a processor to determine geometric fit parameters for an adjusted light seal for the user.

Although the instruction set(s) 740 are shown as residing on a single device, it should be understood that in other implementations, any combination of the elements may be located in separate computing devices. Moreover, FIG. 7 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a processor of a head-mounted device (HMD) comprising one or more inward facing cameras, one or more outward facing cameras, and an initial light seal:
obtaining first images of a portion of a face of a user while the user is wearing the HMD and the initial light seal contacts at least some perimeter regions around the portion of the face such that the HMD forms an enclosed area between the HMD and the portion of the face;
based on the first images, identifying illumination characteristics on the portion of the face corresponding to external light entering the enclosed area via one or more light source leakage regions between the face and the initial light seal; and
based on the identified illumination characteristics, determining one or more parameters for an adjusted light seal for the user.

2. The method of claim 1, wherein said determining the one or more parameters for the adjusted light seal comprises:
modeling external light sources (ambient or strategically placed) in a physical environment of the user wearing the HMD by:
obtaining second images of the physical environment from external facing cameras of the HMD; and
analyzing the second images to identify the illumination characteristics of the first images.

3. The method of claim 1, wherein said determining the one or more parameters for the adjusted light seal comprises:
generating the illumination characteristics with respect to the first images based on simulated attributes of the light seal with respect to contact the face to determine the one or more parameters.

4. The method of claim 3, wherein said generating the illumination characteristics with respect to the first images is performed using a rule-based algorithm.

5. The method of claim 3, wherein said generating the illumination characteristics with respect to the first images is performed using a machine learning (ML) model.

6. The method of claim 1, wherein the first images are obtained by internal facing cameras of the HMD.

7. The method of claim 1, wherein the one or more parameters comprise geometric fit parameters associated with a shape of the face of the user. requiring adjustment.

8. The method of claim 7, wherein the geometric fit parameters comprise parameters selected from the group consisting of angular parameters, curvature parameters, and depth parameters.

9. The method of claim 1, wherein illumination characteristics comprise illumination and shadow patterns located in areas surrounding eyes of the user.

10. The method of claim 1, further comprising:
generating a recommendation for using the adjusted light seal to provide geometric fit parameters to reduce the light source leakage regions.

11. The method of claim 10, wherein the adjusted light seal is a replacement light seal for replacing the initial light seal.

12. The method of claim 10, wherein the adjusted light seal is an adjusted version of the initial light seal.

13. An HMD comprising:
one or more inward facing cameras, one or more outward facing cameras, and an initial light seal;
a non-transitory computer-readable storage medium; and
one or more processors coupled to the non-transitory computer-readable storage medium, wherein the non-transitory computer-readable storage medium comprises program instructions that, when executed on the one or more processors, cause the one or more processors to perform operations comprising:
obtaining first images of a portion of a face of a user while the user is wearing the HMD and the initial light seal contacts at least some perimeter regions around the portion of the face such that the HMD forms an enclosed area between the HMD and the portion of the face;
based on the first images, identifying illumination characteristics on the portion of the face corresponding to external light entering the enclosed area via one or more light source leakage regions between the face and the initial light seal; and
based on the identified illumination characteristics, determining one or more parameters for an adjusted light seal for the user.

14. The HMD of claim 13, wherein said determining the one or more parameters for the adjusted light seal comprises:
modeling external light sources (ambient or strategically placed) in a physical environment of the user wearing the HMD by:
obtaining second images of the physical environment from external facing cameras of the HMD; and
analyzing the second images to identify the illumination characteristics of the first images.

15. The HMD of claim 13, wherein said determining the one or more parameters for the adjusted light seal comprises:
generating the illumination characteristics with respect to the first images based on simulated attributes of the light seal with respect to contact the face to determine the one or more parameters.

16. The HMD of claim 15, wherein said generating the illumination characteristics with respect to the first images is performed using a rule-based algorithm.

17. The HMD of claim 15, wherein said generating the illumination characteristics with respect to the first images is performed using a machine learning (ML) model.

18. The HMD of claim 13, wherein the first images are obtained by internal facing cameras of the HMD.

19. The HMD of claim 13, wherein the one or more parameters comprise geometric fit parameters associated with a shape of the face of the user, requiring adjustment.

20. A non-transitory computer-readable storage medium, storing program instructions executable by one or more processors to perform operations comprising:
at a processor of a head-mounted device (HMD) comprising one or more inward facing cameras, one or more outward facing cameras, and an initial light seal
obtaining first images of a portion of a face of a user while the user is wearing the HMD and the initial light seal contacts at least some perimeter regions around the portion of the face such that the HMD forms an enclosed area between the HMD and the portion of the face;
based on the first images, identifying illumination characteristics on the portion of the face corresponding to external light entering the enclosed area via one or more light source leakage regions between the face and the initial light seal; and
based on the identified illumination characteristics, determining one or more parameters for an adjusted light seal for the user.
